(19) United States
(12) Patent Application Publication
(10) Pub. No.: US 2025/0116525 A1
(43) Pub. Date: Apr. 10, 2025

(54) METHOD AND A SYSTEM FOR TRAVEL ROUTE OPTIMIZATION

(71) Applicant: Leigh M. Rothschild, Miami, FL (US)

(72) Inventor: Leigh M. Rothschild, Miami, FL (US)

(21) Appl. No.: 18/482,610

(22) Filed: Oct. 6, 2023

(51) Int. Cl. G01C 21/34; G01C 21/36

(52) U.S. Cl. CPC G01C 21/3484; G01C 21/3461; G01C 21/3691

(57) ABSTRACT

The present invention relates to method and system for travel route optimization. The method includes receiving origin location and destination location via user interface. The method includes identifying candidate travel routes between origin location and destination location based on parameters. The parameters comprise type of vehicle being driven by driver, condition of vehicle, driver preferences, essential stops enroute, historical travel route information, historical accident information, historical crime data, current diversion data, current weather data. The method includes generating score associated with candidate travel routes. The method includes generating summary associated with candidate travel routes using machine learning techniques. The method includes providing generated score and summary of candidate travel routes alongside preview of candidate travel routes. The method includes receiving second input for selection of final travel route from candidate travel routes. The method includes providing turn-by-turn navigation guidelines to navigate vehicle through final travel route via user interface.

### TECHNICAL FIELD

The present invention relates to a method and a system for navigation systems, and more particularly to a method and system for travel route optimization based on user preferences.

### BACKGROUND

Travel route optimization is a process of finding a best route between two points, considering a variety of factors, such as traffic conditions, road closures, and driver preferences. Traditional travel route optimization methods typically consider only a few factors, such as distance and travel time. However, these methods often do not produce the best route for the driver, as they do not consider other factors that may be important to the driver, such as the condition of the vehicle, the presence of essential stops enroute, or the driver's personal preferences.

Conventional vehicle navigation systems described in the prior art have been widely utilized for decades, aiming to provide drivers with efficient travel routes from an origin to a destination. These systems typically employ algorithms based on maps, traffic data, and distance calculations to generate routes. However, several limitations exist in these traditional navigation systems, hindering their ability to cater to the personalized and dynamic needs of modern drivers. Some key technical problems associated with conventional route generation navigation systems are highlighted below.

Conventional navigation systems often offer a one-size-fits-all approach, disregarding individual driver preferences, vehicle characteristics, and real-time conditions, thereby leading to lack of personalization. Drivers have diverse preferences, such as avoiding highways or selecting scenic routes, but these systems rarely take these personal choices into account.

Inability to Adapt to Vehicle Characteristics: Distinct types of vehicles, such as electric vehicles, trucks, or cars with specific features, have distinct route requirements based on charging stations, road suitability, or load capacity. Traditional navigation systems fail to consider such vehicle-specific characteristics, resulting in suboptimal or impractical routes and thus conventional navigation systems are unable to adapt to vehicle characteristics and vehicle conditions.

Real-time factors like weather conditions, traffic congestions, road closures, and ongoing construction projects significantly impact route optimization. Conventional systems often lack the ability to incorporate these dynamic variables, leading to routes that are inefficient or even unsafe. Traditional navigation algorithms which use static or non-adaptive algorithms tend to be static and pre-programmed. They lack the ability to learn from historical data or dynamically adjust based on user behavior, resulting in outdated recommendations and suboptimal routes.

Past travel history, driver preferences, and patterns are valuable insights that can enhance route recommendations. However, conventional systems overlook this information, missing opportunities for both personalization and improved user experience and this is because of ignoring historical data and user preferences. Conventional navigation systems lack advanced decision-making capabilities with limited intelligence thereby making them incapable of considering complex factors like accident history, crime data, or driver-specific requirements when generating routes. Additionally, machine learning techniques have shown exciting potential in optimizing route generation based on evolving patterns, real-time data, and user feedback. However, traditional systems do not leverage these techniques, limiting their capacity to adapt and improve over time.

Many conventional navigation systems prioritize and overemphasize the shortest distance between two points. While this approach may be suitable for some cases, it neglects critical considerations, such as driving conditions, driver comfort, essential stops, and potential hazards.

To address these limitations and offer a more personalized, adaptive, and optimized navigation experience, there is a need for an improved travel route optimization navigation system a novel approach is needed. This disclosure details a method and system that solves the problem with current navigation and routing technologies and offers the user a valuable resource in operating a vehicle.

U.S. Ser. No. 11/493,345B1 teaches about a vehicle routing system which includes a vehicle routing and analytics (VRA) computing device, one or more databases, and one or more vehicles communicatively coupled to the VRA computing device. The VRA computing device is configured to generate an optimal route for a vehicle to travel that maximizes potential revenue for operation of the vehicle, the optimal route including a schedule of a plurality of tasks, and generate analytics associated with operation of the vehicle. The VRA computing device is further configured to provide a management hub software application accessible by vehicle users associated with vehicles, tasks sources, and other users.

WO2023021162A2 teaches about a vehicle embedded or mobile-phone-based, automated dynamic routing unit associated with a vehicle and/or a user along a route traveled and method thereof. The dynamic routing unit provides an optimized route between a departure location and a destination location. The automated dynamic routing unit comprises a routing interface for receiving destination input parameters of a destination location and/or departure location input parameters of a departure location. The automated dynamic routing unit comprises a routing generator for generating one or more routes between the departure location and the destination location.

U.S. Pat. No. 10,467,218B2 teaches about a neural network that is used in a vehicle component to determine the stress level or arousal level of a vehicle occupant. Sensors in the vehicle cabin, e.g., the seat, sense biological characteristics of the occupant, e.g., neuro-electrical signals, cardiac characteristics, body temperature and the like. The neural network can compute and classify the emotional state of the occupant in real-time. The vehicle can trigger warnings, indicators, and stress countermeasures when the occupant exceeds a threshold. The countermeasures can include visual and audio feedback within the vehicle cabin. The neural network can provide historical occupant emotional states that can be used by the navigation system to avoid travel segments that may trigger undesired emotional states in the occupant.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for generating a travel route for navigation of a vehicle. The method may be implemented by an electronic device or an application server including one or more processors, and, in an embodiment, the electronic device may be disposed in the vehicle. The method may include receiving a first input comprising an origin location and a destination location via a user interface. The method may include identifying one or more candidate travel routes from a plurality of travel routes between the origin location and the destination location based on a plurality of parameters associated with each of the plurality of travel routes. In an embodiment, the plurality of parameters comprises a type of vehicle being driven by a driver, a condition of the vehicle, a plurality of driver preferences, a plurality of essential stops enroute, a historical travel route information, a historical accident information, a historical crime data, a current diversion data, a current weather data and other user preferences The method may include generating a score associated with each of the one or more candidate travel routes. The method may include generating a summary associated with each of the one or more candidate travel routes using a machine learning technique included and not limited to artificial intelligence. The method may include providing the generated score and the summary of each of the one or more candidate travel routes alongside a preview of each of the one or more candidate travel routes. The method may include receiving a second input for selection of a final travel route from the one or more candidate travel routes in response to providing the generated score and the summary of each of the one or more candidate travel routes. The method may include providing turn-by-turn navigation guidelines to navigate the vehicle through the final travel route via the user interface.

According to embodiments illustrated herein, there may be provided a system that includes an electronic device, an application server and a communication network configured to generate an optimized travel route for navigation. The system comprises a processor and a computer-readable medium communicatively coupled to the processor. The processor is configured to receive a first input comprising an origin location and a destination location via a user interface. The processor is configured to identify one or more candidate travel routes from a plurality of travel routes between the origin location and the destination location based on a plurality of parameters associated with each of the plurality of travel routes. In an embodiment, the plurality of parameters comprises a type of vehicle being driven by a driver, a condition of the vehicle, a plurality of driver preferences, a plurality of essential stops enroute, a historical travel route information, a historical accident information, a historical crime data, a current diversion data, a current weather data and other user preferences. The processor is configured to generate a score associated with each of the one or more candidate travel routes. The processor is configured to generate a summary associated with each of the one or more candidate travel routes using a machine learning technique. The processor is configured to provide the generated score and the summary of each of the one or more candidate travel routes alongside a preview of each of the one or more candidate travel routes. The processor is configured to receive a second input for selection of a final travel route from the one or more candidate travel routes in response to providing the generated score and the summary of each of the one or more candidate travel routes. The processor is configured to provide turn-by-turn navigation guidelines to navigate the vehicle through the selected final travel route via the user interface.

The claimed invention is not considered abstract because the disclosure involves specific and practical steps to achieve a tangible result, i.e., generating an optimized travel route for navigation of a vehicle. The claimed method includes receiving inputs, identifying candidate travel routes based on various parameters, generating scores and summaries, providing options to the user, and offering turn-by-turn navigation guidelines. These steps are concrete and clearly outline a specific process to achieve the desired outcome.

Additionally, a human would not be able to perform the claimed invention with the same efficiency and accuracy as the disclosed method due to several reasons:
Data Processing: The method involves processing vast amounts of data, including historical travel routes, accident data, crime statistics, weather conditions, and various driver preferences. Humans would struggle to efficiently analyze and interpret such large datasets in real-time.
Machine Learning Techniques: The invention employs machine learning techniques to generate summaries associated with candidate routes. These techniques enable the system to learn from historical data and driver preferences, making the navigation process more personalized and optimized. Humans would find it challenging to replicate such intelligent decision-making and learning capabilities.
Real-Time Updates: The system considers real-time data, such as current weather conditions and enroute diversions. Humans would not be able to access and process this information as rapidly and effectively as a processor can.
Multivariable Optimization: The method optimizes travel routes based on multiple parameters simultaneously, including vehicle type, condition, driver preferences, and various data sources. This multi-dimensional optimization is beyond the capabilities of human navigators, who may prioritize certain factors while neglecting others.
Turn-by-Turn Navigation: Providing turn-by-turn navigation guidelines requires continuous monitoring of the vehicle's position and real-time adjustments to the route based on dynamic conditions. This level of precise and dynamic navigation is not practically achievable by a human without the aid of a computerized system.

The machine learning technique/artificial intelligence (AI) used in the claimed invention is a specific and meaningful way to process data and generate a score for each of the candidate travel routes. The score is a concrete and useful output of the invention, and it helps the driver to select the best route. Further, the AI-related summary generation is another concrete and useful output of the invention. The summary provides the driver with information about the candidate travel routes, and it helps the driver to understand the reasons why the invention has generated a particular score for each route.

Specifically, the combination of the machine learning, the score computed, and the AI-related summary generation demonstrates that the invention is not an abstract idea. The invention is a concrete and practical solution to a technical problem, and it is capable of being implemented in a computer program. In addition, the invention solves a real-world problem that drivers face. Drivers often need to find the best route between two points, and the invention helps them to do this by considering a wider range of factors than prior art methods.

In summary, the claimed invention is not abstract because it describes a concrete and specific method with practical applications. The involvement of machine learning, real-time data processing, and multi-dimensional optimization sets it apart from tasks that can be performed manually by a human. The efficiency, accuracy, and personalized nature of the invention demonstrate that human performance would be inadequate to replicate its functionalities effectively.

The claimed invention involves specific technical components and processes that are applied in a real-world context and has a practical application. The claimed invention combines various elements such as capturing and correlation plurality of parameters, sensor data, machine learning techniques, and real-time data processing to solve a specific technical problem related to travel route generation for navigation of a vehicle. The claimed invention utilizes these technical components in a novel and non-obvious manner to provide a practical solution.

In view of the above, the claimed invention combines specific application of technology, real-time data analysis, and optimized travel route generation for navigation to solve a practical problem in navigation system, making it more than an abstract idea or a simple task that a human could perform without the aid of such technology.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments of the method and the system may be implemented;

FIG. 2 is a block diagram that illustrates an application server configured for generating a travel route for navigation of a vehicle, in accordance with an embodiment of the present disclosure; and

FIG. 3 is a flowchart that illustrates a method for generating a travel route for navigation of a vehicle, in accordance with an embodiment of the present disclosure.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention provides a method and a system for travel route optimization that overcomes the limitations of prior art methods. The method of the present invention considers a wider range of factors than traditional methods, such as the type of vehicle, the condition of the vehicle, the driver's preferences, the historical travel route information, the historical accident information, the historical crime data, the current diversion data, and the current weather data. The method of the present invention also generates a score for each of the candidate travel routes, which indicates the relevance of the route to the driver. The driver can then select the route with the highest score.

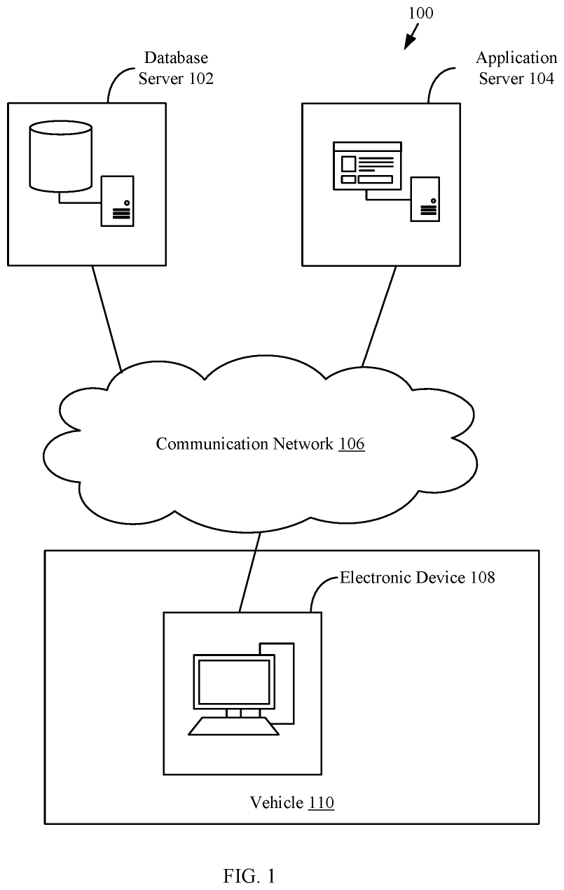

FIG. 1 is a block diagram that illustrates a system environment 100 in which various inventive embodiments of the method and system may be implemented. The system environment 100 typically includes an electronic device 104, a database server 102, a communication network 106, and an application server 104. In an embodiment, electronic device 104 may be disposed in a vehicle within an instrument cluster of the vehicle. The electronic device 104, the database server 102, and the application server 104 are typically communicatively coupled with each other via the communication network 106. In an embodiment, the electronic device 104 may communicate with the database server 102, and the application server 104 using one or more protocols such as, but not limited to, Open Database Connectivity (ODBC) protocol and Java Database Connectivity (JDBC) protocol.

The electronic device 104 may refer to a computing device disposed within the vehicle. The electronic device 104 may comprise of one or more processors and one or more memories. The one or more memories may include computer readable code that may be executable by the one or more processors to perform predetermined operations. In an embodiment, the electronic device 104 may present a user-interface to the rider of the vehicle for providing a first input and a second input. Examples of the electronic device 104 may include, but are not limited to, a personal computer, a laptop, a personal digital assistant (PDA), a mobile device which may include a tablet, smart phone, or smart watch such as an Apple Watch®, the head unit built onto the vehicle, or any other computing device.

The electronic device 104 is preferably configured to receive the first input comprising an origin location and a destination location via a user interface. The electronic device 104 may be configured to identify one or more candidate travel routes from a plurality of travel routes between the origin location and the destination location based on a plurality of parameters associated with each of the plurality of travel routes. The electronic device 104 may be configured to generate a score associated with each of the one or more candidate travel routes generate a summary associated with each of the one or more candidate travel routes using a machine learning technique. The electronic device 104 may be configured to provide the generated score and the summary of each of the one or more candidate travel routes alongside a preview of each of the one or more candidate travel routes. The electronic device 104 may be configured to receive a second input for selection of a final travel route from the one or more candidate travel routes in response to providing the generated score and the summary of each of the one or more candidate travel route. The electronic device 104 may be configured to provide turn-by-turn navigation guidelines to navigate the vehicle through the final travel route via the user interface.

In an embodiment, the database server 102 may refer to a computing device that may be configured to store information comprising a type of vehicle being driven by a driver, a condition of the vehicle, a plurality of driver preferences, a plurality of essential stops enroute, a historical travel route information, a historical accident information, a historical crime data, a current diversion data, a current weather data or other user preferences. It is to be noted that in an embodiment the database server may be located locally in the vehicle or on a cloud-based server. In an embodiment, the database server 102 may include a special purpose operating system specifically configured to perform one or more database operations on the aforementioned information. Examples of database operations may include, but are not limited to, Select, Insert, Update, Push, Pull, and Delete. In an embodiment, the database server 102 may include hardware that may be configured to perform one or more predetermined operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like. In an embodiment, the database server 102 may be implemented in the electronic device 104 or the application server 104.

In an embodiment, the database server 102 may be configured to transmit the aforementioned information to the electronic device 104 for data processing, via the communication network 106. In an embodiment, the database server 102 may be configured to store the score associated with each of the one or more candidate travel routes and also the generated summary. In an embodiment, the database server 102 may be configured to store the aforementioned information to be displayed to the plurality of riders of the vehicle.

A person with ordinary skills in the art will understand that the scope of the disclosure is not limited to the database server 102 as a separate entity. In an embodiment, the functionalities of the database server 102 can be integrated into the electronic device 104 or the application server 104.

In an embodiment, the communication network 106 may correspond to a communication medium through which the electronic device 104, the database server 102, and the application server may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G, 5G, 6G cellular communication protocols, and/or Bluetooth (BT) communication protocols, or satellite communication, for example. Additionally, the communication network 106 may include, but is not limited to, the Internet, a cloud network, a Wireless Fidelity (Wi-Fi) network, a Wireless Local Area Network (WLAN), a Local Area Network (LAN), satellite communication, a telephone line (POTS), and/or a Metropolitan Area Network (MAN).

The application server 104 may refer to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The application server 104 may be realized through several types of application servers such as, but are not limited to, a Java application server, a .NET framework application server, a Base4 application server, a PHP framework application server, or any other application server framework.

A person having ordinary skill in the art will appreciate that the scope of the disclosure is not limited to realizing the application server 104 and the electronic device 104 as separate entities. In an embodiment, the application server 104 may be realized as an application program installed on and/or running on the electronic device 104 and vice versa without departing from the scope of the disclosure.

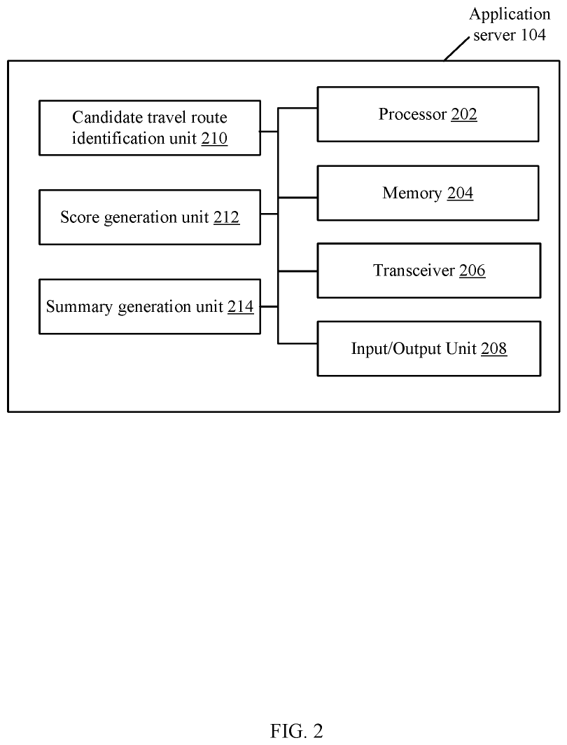

FIG. 2 is a block diagram that illustrates an application server 104 configured for generating a travel route for navigation of a vehicle, in accordance with an embodiment of the present disclosure. FIG. 2 is explained in conjunction with elements from FIG. 1. Here, the application server 104 preferably includes a processor 202, a memory 204, a transceiver 206, an input/output unit 208, a candidate travel route generation unit 210, a score generation unit 212, and a summary generation unit. The processor 202 is further preferably communicatively coupled to the memory 204, the transceiver 206, the input/output unit 208, the candidate travel route generation unit 210, the score generation unit 212, and the summary generation unit, while the transceiver 206 is preferably communicatively coupled to the communication network 106.

The processor 202 comprises suitable logic, circuitry, interfaces, and/or code that may be configured to execute a set of instructions stored in the memory 204, and may be implemented based on several processor technologies known in the art. The processor 202 works in coordination with the transceiver 206, the input/output unit 208, and the speed controlling 210 for controlling speed of the vehicle. Examples of the processor 202 include, but not limited to, an X86-based processor, a Reduced Instruction Set Computing (RISC) processor, an Application-Specific Integrated Circuit (ASIC) processor, and a Complex Instruction Set Computing (CISC) processor, Intelligence Processing Unit (IPU), among others.

The memory 204 comprises suitable logic, circuitry, interfaces, and/or code that may be configured to store the set of instructions, which are executed by the processor 202. Preferably, the memory 204 is configured to store one or more programs, routines, or scripts that are executed in coordination with the processor 202. Additionally, the memory 204 may be implemented based on a Random Access Memory (RAM), a Read-Only Memory (ROM), a Hard Disk Drive (HDD), an optical drive, a storage server either local or cloud based, and/or a Secure Digital (SD) card or Flash Drive.

The transceiver 206 comprises suitable logic, circuitry, interfaces, and/or code that may be configured to receive a GPS location associated with the vehicle. The transceiver 206 is preferably configured to receive information pertaining to the plurality of parameters to be considered for travel router generation. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, audio inputs and outputs, and/or a local buffer. Also, the transceiver 206 may communicate via wireless communication with networks, such as the Internet, an Intranet and/or a wireless network, such as a cellular telephone network, a wireless local area network (LAN), a satellite network, and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Satellite communication, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output unit 208 comprises suitable logic, circuitry, interfaces, and/or code that may be configured to provide one or more inputs comprising the first input and the second input for generation of the travel route. The input/output unit 208 comprises of various input and output devices that are configured to communicate with the processor 202. Examples of the input devices include, but are not limited to, a keyboard, a mouse, a joystick, a touch screen, eye tracking sensors, a microphone, a camera, and/or a docking station. Examples of the output devices include, but are not limited to, a display screen and/or a speaker. The display screen is preferably configured to: display the generated score, AI generated summary and a user interface which further enables to select the final travel route and display the turn-by-turn navigation. The speaker may use audio to communicate the turn-by-turn navigation to the driver.

The candidate travel route generation unit 210 comprises suitable logic, circuitry, interfaces, and/or code that may be configured to identify one or more candidate travel routes from a plurality of travel routes between the origin location and the destination location based on a plurality of parameters associated with each of the plurality of travel routes. The score generation unit 212 comprises suitable logic, circuitry, interfaces, and/or code that may be configured to generate a score associated with each of the one or more candidate travel routes. The summary generation unit comprises suitable logic, circuitry, interfaces, and/or code that may be configured to generate a summary associated with each of the one or more candidate travel routes using a machine learning technique.

In an exemplary operation, the electronic device may be configured to receive the first input comprising an origin location and a destination location via the user interface. In an embodiment, the first input and the second input being provide using at least one of a touch input, a voice input.

The candidate travel route generation unit 210 may be configured for identifying one or more candidate travel routes from a plurality of travel routes between the origin location and the destination location based on a plurality of parameters associated with each of the plurality of travel routes. For example, between origin A and destination B 10 candidate paths may be identified. In an embodiment, the plurality of parameters comprises but is not limited to the type of vehicle being driven by a driver, a condition of the vehicle, a plurality of driver preferences, a plurality of essential stops enroute, a historical travel route information, a historical accident information, a historical crime data, a current diversion data, a current weather data;

In an embodiment, the type of vehicle comprises an SUV, an MPV, a sedan, a truck, a commercial vehicle, and an electric vehicle. In an embodiment, the condition of the vehicle being identified using one or more sensors disposed within the vehicle. In an embodiment, the condition of the vehicle comprises at least one of: the age of the vehicle, noise level of the vehicle, emission data, tire conditions, battery SOH, battery SOC.

In an embodiment, the plurality of driver preferences comprises lighting conditions during driving, daytime, nighttime, freeways, countryside roads, potholes, acceleration, speed, enroute traffic signals, enroute diversions due to constructions, fencing. In an embodiment, the plurality of essential stops enroute comprises at least one of hospitals, food stores, museums, gas stations, EV charging stations, doctors' offices, restaurants, parks, stopping rest areas, amusement parks, and vehicle service stations.

In an embodiment, the past travel route history information comprises user's previous routes, success rates, timings, and traffic history based on time of day and past days' averages. In an embodiment, the accident history information comprises timestamp of the historical accidents, severity of the accidents, a count of accidents associated with each intersection or an accident-prone zone, availability of nearby emergency facilities.

In an embodiment, the historical crime data comprises statistics on crimes along the plurality of candidate travel routes, wherein the diversion data comprises detours identified due to ongoing enroute constructions. In an embodiment, the weather data comprises current and forecasted weather conditions along the plurality of candidate travel routes that affect driving conditions.

After the candidate routes are identified based on the plurality of parameters being captured as input from the driver of the vehicle through either voice commands or touch commands, the score generation unit may be configured for generating a score associated with each of the one or more candidate travel routes.

In an embodiment, the score is generated by using a plurality of machine learning models. For example, in an embodiment, the score being between 1-100 and a score closer to 100 being the most relevant and optimized route for the driver.

After generating the score, the summary generation unit may be configured for generating a summary associated with each of the one or more candidate travel routes using a machine learning technique. In an embodiment, the summary is generated by using a plurality of natural language processing machine learning models.

Further, the generated score and the summary being displayed on the user interface or being provided to the driver either through text or voice-based communication. The input/output unit may be configured for providing the generated score and the summary of each of the one or more candidate travel routes alongside a preview of each of the one or more candidate travel routes.

In response to providing the generated score and the summary of each of the one or more candidate travel routes, a second input for selection of a final travel route from the one or more candidate travel routes may be received from the driver. After receiving the second input, the input/output unit may be configured for providing turn-by-turn navigation guidelines to navigate the vehicle through the final travel route via the user interface.

In an embodiment, by maintaining the below information the travel route can be more personalized and optimized.

Vehicle Database: Maintain a database of vehicles along with relevant information such as their age, noise level, fuel efficiency, and other condition-related parameters. This database can serve as a reference for route optimization.

Vehicle Profiling: Profile each vehicle based on its condition attributes, including age and noise level. Assign weights or scores to these attributes to reflect their impact on the optimization process.

Noise Level Constraints: Set noise level constraints for route optimization, considering local regulations or user preferences. For example, the system can avoid routes that pass-through noise-sensitive areas such as residential neighborhoods or noise-restricted zones.

Maintenance Schedule Integration: Incorporate vehicle maintenance schedules into the route optimization system. If a vehicle is due for maintenance or has specific requirements, consider this information when generating routes. Avoid routes that may strain the vehicle or exacerbate existing issues.

Efficient Routing for Older Vehicles: Older vehicles may have different performance characteristics or fuel efficiency levels. Optimize routes to minimize fuel consumption and consider the potential impact on older vehicles, such as avoiding steep inclines or congested areas that may strain the engine.

Real-Time Monitoring: Integrate real-time vehicle monitoring systems to gather data on factors like noise levels, engine performance, or fuel consumption. Use this data to dynamically adjust the optimization process and suggest alternative routes if the vehicle condition changes during the trip.

User Feedback and Preferences: Allow users to provide feedback on their vehicle condition-related preferences. For instance, some users may prefer quieter routes or routes that avoid certain road conditions based on their vehicle's age or noise level. Incorporate this feedback into the route optimization process to better align with user preferences. Further, allow drivers to input their preferences regarding night driving and freeway usage. This can be done through a user interface or settings where drivers can indicate their preferences.

Safety Considerations: Consider safety aspects when generating routes based on driver preferences. For example, if a driver prefers night driving but safety is a concern in certain areas, the system can avoid routes that have higher crime rates or poor visibility during nighttime. In an embodiment, a driver may avoid roads that have ongoing road constructions as such road constructions may hinder the driver and may additionally not be safe,

Feedback and Learning: Gather feedback from drivers regarding their route preferences and experiences. Analyze this feedback to improve the route optimization algorithms over time and provide more accurate recommendations that align with driver preferences.

By incorporating vehicle condition parameters into the route optimization process, the system may generate routes that consider the specific needs of each vehicle and provide a more personalized and satisfactory driving experience. This helps ensure a more comfortable and efficient travel experience while considering factors like age, noise level, and maintenance requirements and also ensures that drivers are guided along routes that suit their preferences while considering factors like time, traffic conditions, and safety.

In a first working example, let us say a driver wants to travel from San Francisco to Los Angeles. The driver's vehicle is a sedan, and the driver prefers scenic routes. The driver also has a medical appointment in Los Angeles, so they need to make a stop at a hospital along the way.

The system would first identify the plurality of parameters associated with each of the plurality of travel routes. These parameters would include the type of vehicle, the condition of the vehicle, the driver's preferences, the plurality of essential stops enroute, the historical travel route information, the historical accident information, the historical crime data, the current diversion data, and the current weather data.

The system would then use the machine learning/artificial intelligence model to generate a score associated with each of the one or more candidate travel routes. The score would indicate the relevance of the route to the driver. The system would also generate a summary associated with each of the one or more candidate travel routes. The summary would provide the driver with information about the candidate travel routes, such as the length of the route, the estimated travel time, and the number of essential stops along the route.

The system would then provide the driver with the generated score and the summary of each of the one or more candidate travel routes alongside a preview of each of the one or more candidate travel routes. The driver could then select the final travel route from the one or more candidate travel routes.

The system would then provide the driver with turn-by-turn navigation guidelines to navigate the vehicle through the final travel route. The turn-by-turn navigation guidelines would include the instructions on how to drive to the final destination, as well as the instructions on how to make any necessary stops along the way. In this example, the system would identify one or more candidate travel routes that meet the driver's criteria.

In another working example, let us consider that the driver Sarah wants to generate a personalized travel route based on her various preferences.
Origin: Sarah's Home
Destination: Grand Central Park

Step 1: Sarah opens the travel route optimization application on her vehicle's navigation system. The user interface prompts her to enter the origin (Sarah's Home) and the destination (Grand Central Park).

Step 2: Sarah selects the type of vehicle she is driving, which is an electric vehicle (EV).

Step 3: The system's sensors within Sarah's EV measure its battery state-of-health (SOH) and state-of-charge (SOC). The system determines that the vehicle's battery is in good condition, ensuring it can handle longer routes without needing frequent charging.

Step 4: The system asks Sarah about her preferences. She selects “daytime driving,” “freeways,” and “restaurants” as essential stops enroute.

Step 5: The processor accesses historical data of Sarah's previous travel routes and driver preferences. It considers Sarah's past successful routes and preferences for daytime driving and freeways.

Step 6: The processor also analyzes historical accident data and crime statistics along the candidate routes. It identifies that a particular route has a higher accident count but is still within reasonable limits for safety.

Step 7: The processor checks real-time weather data and identifies that there is a chance of rain on one of the candidate routes, affecting driving conditions.

Step 8: The system generates a score for each candidate route based on the parameters considered. The route that aligns with Sarah's preferences, EV condition, historical data, and has fewer accidents receives a higher score.

Step 9: The system utilizes machine learning to create a summary for each candidate route.

For example, it informs Sarah that the route with the highest score has more restaurants and is likely to be faster due to its freeway usage.

Step 10: The system presents the candidate routes with their respective scores and summaries on the user interface. Sarah reviews the options and selects the route with the highest score, considering the provided summary and her preferences. In an embodiment, Sarah can also select another candidate route with a lesser score for travelling.

Step 11: The system provides turn-by-turn navigation guidelines to guide Sarah through the chosen optimized route, considering real-time traffic and weather updates.

Step 12: Sarah follows the turn-by-turn directions and successfully reaches her destination at Grand Central Park, having enjoyed a smooth, personalized, and optimized travel experience.

In this example, the invention's method and system employed machine learning, computed a score based on various parameters, and generated an AI-related summary to optimize and personalize the travel route for Sarah's electric vehicle journey. The tangible and specific application of the invention demonstrates its practical utility.

A person skilled in the art will understand that the scope of the disclosure is not limited to generating the travel route based on the aforementioned factors and using the aforementioned techniques, and that the examples provided do not limit the scope of the disclosure.

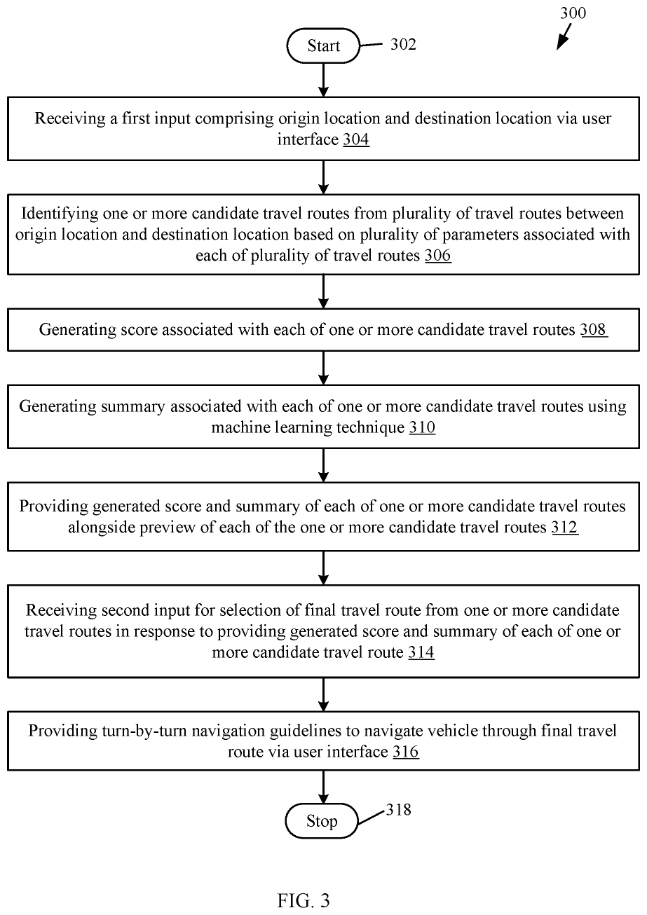

FIG. 3 is a flowchart that illustrates a method 300 for generating a travel route for navigation of a vehicle, in accordance with an embodiment of the present disclosure. The method begins in at Start step 302 and proceeds to a step 304.

At step 304, the application server is configured to receive, by a processor, a first input comprising an origin location and a destination location via a user interface. At step 306, the application server is configured to identifying, by the processor, one or more candidate travel routes from a plurality of travel routes between the origin location and the destination location based on a plurality of parameters associated with each of the plurality of travel routes. In an embodiment, the plurality of parameters comprises a type of vehicle being driven by a driver, a condition of the vehicle, a plurality of driver preferences, a plurality of essential stops enroute, a historical travel route information, a historical accident information, a historical crime data, a current diversion data, a current weather data.

At step 308, the application server is configured to generate, by the processor, a score associated with each of the one or more candidate travel routes. At step 310, the application server is configured to generate, by the processor, a summary associated with each of the one or more candidate travel routes using a machine learning technique. At step 312, the application server is configured to provide, by the processor, the generated score, and the summary of each of the one or more candidate travel routes alongside a preview of each of the one or more candidate travel routes.

At step 314, the application server is configured to receiving, by the processor, a second input for selection of a final travel route from the one or more candidate travel routes in response to providing the generated score and the summary of each of the one or more candidate travel route. At step 316, the application server is configured to provide, by the processor, turn-by-turn navigation guidelines to navigate the vehicle through the final travel route via the user interface. Control passes to end step 318.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Various embodiments of the disclosure encompass numerous advantages including methods and systems for generating a travel route for navigation of a vehicle. The disclosed method and system have several technical advantages that are significant improvements of the prior art but not limited to the following:
User-Friendly Interface: The use of a user interface allows users to easily input the origin and destination locations, making the route generation process simple and accessible for all users.
Real-Time Processing: The involvement of a processor enables real-time processing of the input data, allowing for immediate route calculations and optimizations.
Efficient Route Optimization: By leveraging the processor's computational capabilities, the method can efficiently calculate and optimize the travel route, considering factors such as a type of vehicle being driven by a driver, a condition of the vehicle, a plurality of driver preferences, a plurality of essential stops enroute, a historical travel route information, a historical accident information, a historical crime data, a current diversion data, a current weather data.
Customization: The method likely includes provisions for user preferences, enabling the generation of personalized routes tailored to individual user needs and preferences.
Adaptive Route Adjustments: The processor's dynamic capabilities can adjust the route in real-time based on changes in traffic conditions or user inputs during the journey, ensuring the most optimal path is followed.
Fast Response Times: With a processor handling the calculations, the method can deliver route recommendations swiftly, allowing users to commence their journeys promptly.
Scalability: The method can be scaled to accommodate a large number of users simultaneously, making it applicable for widespread usage in various vehicles and navigation systems.
Accuracy: The involvement of a processor ensures precise route calculations, minimizing errors and inaccuracies in the generated routes.
Integration with Mapping Data: The method likely integrates with mapping data and GPS systems, utilizing comprehensive maps to provide accurate and up-to-date navigation instructions.
Machine Learning: The utilization of machine learning techniques demonstrates a specific and practical application of AI technology to solve a real-world problem. Machine learning involves training algorithms to learn patterns and make data-driven decisions to generate summaries associated with candidate travel routes.
Computed Score: The process of computing a score for each candidate travel route involves analyzing multiple parameters, historical data, and real-time factors, such as vehicle condition, driver preferences, accident history, crime statistics, and weather conditions. This step provides a concrete and quantifiable result based on specific data points and criteria, making it more than an abstract idea or mental process. The combination of all of these factors occurring simultaneously would make it impossible for the human brain to calculate an exact or even an approximate outcome.
AI-Related Summary Generation: The AI-related summary generation aspect of the invention shows a practical implementation of AI technology to assist users in making informed decisions. Summarizing travel route information based on historical data and preferences is a valuable and non-trivial application of AI. The summaries add real value to the navigation process and are not merely theoretical concepts.
By incorporating these elements into the invention, the patent application demonstrates a specific and tangible improvement to the field of vehicle navigation. It goes beyond mere abstract ideas and provides a technical solution that utilizes machine learning, real-time data processing, and intelligent decision-making.

The claimed invention considers a wider range of factors when generating a travel route. This means that the system is more likely to generate a route that is relevant to the driver's needs. For example, the system can consider the type of vehicle, the condition of the vehicle, the driver's preferences, the historical travel route information, the historical accident information, the historical crime data, the current diversion data, and the current weather data. The claimed invention generates a score for each of the candidate travel routes. This score indicates the relevance of the route to the driver. This allows the driver to select the route that is most likely to meet their needs and thus is more personalized. The user-friendly interface makes it easy for the driver to input their travel information and to select the best route based on the displayed score and the AI generated summary. The claimed invention further uses a machine learning/artificial intelligence technique to generate the score for each of the candidate travel routes. This ensures that the score is accurate and that it is based on the most relevant factors.

These elements are not combined in any prior art method, and the combination of these elements produces a new and non-obvious invention. In addition, the invention is not obvious because it solves a technical problem that was not previously solved by prior art methods. The prior art methods for travel route optimization typically only consider a few factors, such as distance and travel time. However, these methods often do not produce the best route for the driver, as they do not consider other factors that may be important to the driver, such as the condition of the vehicle, the presence of essential stops enroute, or the driver's personal preferences. The invention solves this problem by considering a wider range of factors when generating a travel route. This means that the system is more likely to generate a route that is relevant to the driver's needs.

Therefore, the invention is not obvious to a person skilled in the art because it combines a number of different elements in a new and non-obvious way, and it solves a technical problem that was not previously solved by prior art methods.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit or multiple integrated circuits that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

1. A method for generating a travel route for navigation of a vehicle, the method comprising:
receiving, by a processor, a first input comprising an origin location and a destination location via a user interface;
identifying, by the processor, one or more candidate travel routes from a plurality of candidate travel routes between the origin location and the destination location based on a plurality of parameters associated with each of the plurality of travel routes,
wherein the plurality of parameters includes at least one parameter selected from the set of parameters consisting of: features of the vehicle being driven by a driver, a condition of the vehicle, a plurality of driver preferences, a plurality of stops enroute, a historical travel route information, a historical accident information, a historical crime data, a current diversion data, a current weather data;
determining, by the processor, a relevancy between the at least one parameter and each route of the one or more candidate travel routes:
generating, by the processor, a score associated with each of the plurality of candidate travel routes based on the relevancy between the at least one parameter and each route of the one or more candidate travel routes, wherein the score is directly proportional of the relevancy between the at least one parameter and each route of the one or more candidate travel routes;
generating, by the processor, a summary associated with each of the plurality of candidate travel routes using a machine learning technique;
providing, by the processor, the generated score and the summary of at least one of the plurality of candidate travel routes alongside a preview of said at least one candidate travel routes;
receiving, by the processor, a second input for selection of a final travel route from the plurality of candidate travel routes in response to providing the generated score and the summary of each of the at least one candidate travel route; and
providing, by the processor, turn-by-turn navigation guidelines to navigate the vehicle through the final travel route via the user interface.

2. The method for generating the travel route for navigation of the vehicle as claimed in claim 1, wherein the generated score and the summary is provided to the driver by a communication means selected from the set of communication means consisting of: being displayed on the user interface, being provided to the driver through text communication and being provided to the driver through voice-based communication.

3. The method for generating the travel route for navigation of the vehicle as claimed in claim 1, wherein the first input and the second input being provided using at least one of a touch input, a voice input.

4. The method for generating the travel route for navigation of the vehicle as claimed in claim 1, wherein the features of the vehicle is selected for a set of vehicle types consisting of: a Sport Utility Vehicle (SUV), a Multi Utility Vehicle (MPV), a sedan, a truck, a commercial vehicle, and an electric vehicle.

5. The method for generating the travel route for navigation of the vehicle as claimed in claim 1, wherein the condition of the vehicle is identified using at least one sensor disposed within the vehicle, said at least one sensor monitoring at least one condition being selected from the set of conditions consisting of: the age of the vehicle, the noise level of the vehicle, emission data, tire conditions, battery State of Health (SOH), and battery State of Charge (SOC).

6. The method for generating the travel route for navigation of the vehicle as claimed in claim 1, wherein the plurality of driver preferences comprises at least one preference selected from the set of preferences consisting of: lighting conditions during driving, daytime, nighttime, freeways, countryside roads, potholes, acceleration, speed, enroute traffic signals, enroute diversions due to construction, and accidents.

7. The method for generating the travel route for navigation of the vehicle as claimed in claim 1, wherein the plurality of stops enroute comprises at least one stop selected from the set of stops consisting of: hospitals, food stores, museums, gas stations, Electric Vehicle (EV) charging stations, doctors' offices, restaurants, parks, stopping rest areas, and vehicle service stations.

8. The method for generating the travel route for navigation of the vehicle as claimed in claim 1, wherein the past travel route history information comprises at least one past history data selected from the set of past history data consisting of: user's previous routes, success rates, timings, and traffic history based on time of day and past days' averages.

9. The method for generating the travel route for navigation of the vehicle as claimed in claim 1, wherein the accident history information comprises at least one accident history data selected from the set of accident history data consisting of: timestamp of the historical accidents, severity of the accidents, a count of accidents associated with each intersection, a count of accidents associated with an accident-prone zone, and availability of nearby emergency facilities.

10. The method for generating the travel route for navigation of the vehicle as claimed in claim 1, wherein the historical crime data comprises statistics on crimes along the plurality of candidate travel routes, wherein the diversion data comprises detours identified due to ongoing enroute constructions.

11. The method for generating the travel route for navigation of the vehicle as claimed in claim 1, wherein the weather data comprises current and forecasted weather conditions along the plurality of candidate travel routes that affect driving conditions.

12. The method for generating the travel route for navigation of the vehicle as claimed in claim 1, wherein the plurality of parameters is captured as input from the driver of the vehicle through at least one diver input systems selected from the set of driver input systems consisting of voice commands and touch commands.

13. The method for generating the travel route for navigation of the vehicle as claimed in claim 1, wherein the score being between 1-100 inclusively and a score closer to 100 being the most relevant and optimized route for the driver.

14. A system to generate a travel route for navigation of a vehicle, the system comprising:
a processor; and
a computer-readable medium communicatively coupled to the processor, wherein the computer-readable medium stores processor-executable instructions, which when executed by the processor, cause the processor to:
receive a first input comprising an origin location and a destination location via a user interface;
identify at least one candidate travel routes from a plurality of travel routes between the origin location and the destination location based on a plurality of parameters associated with each of the plurality of travel routes,
wherein the plurality of parameters is selected from the set of parameters consisting of: features of vehicle being driven by a driver, a condition of the vehicle, a plurality of driver preferences, a plurality of stops enroute, a historical travel route information, a historical accident information, a historical crime data, a current diversion data, and a current weather data;
determine a relevancy between the at least one parameter and each route of the one or more candidate travel routes;
generate a score associated with each of the plurality of candidate travel routes based on the relevancy between the at least one parameter and each route of the one or more candidate travel routes, wherein the score is directly proportional of the relevancy between the at least one parameter and each route of the one or more candidate travel routes;
generate a summary associated with each of the plurality of candidate travel routes using a machine learning technique;
provide the generated score and the summary of at least one of the plurality of candidate travel routes alongside a preview of at least one of the plurality of candidate travel routes;
receive a second input for selection of a final travel route from the at least one of the plurality of candidate travel routes in response to providing the generated score and the summary of each of the at least one of the plurality of candidate travel route; and
provide turn-by-turn navigation guidelines to navigate the vehicle through the final travel route via the user interface.

15. A method for generating a travel route for navigation of a vehicle, the method comprising:
receiving, by a processor, a first input comprising an origin location and a destination location via a user interface;
identifying, by the processor, at least one candidate travel routes from a plurality of travel routes between the origin location and the destination location based on a plurality of parameters associated with each of the plurality of travel routes,
wherein the plurality of parameters includes at least one parameter selected from the set of parameters consisting of: features of the vehicle being driven by a driver, a condition of the vehicle, a plurality of driver preferences, a plurality of stops enroute, a historical travel route information, a historical accident information, a historical crime data, a current diversion data, and a current weather data;
determining, by the processor, a relevancy between the at least one parameter and each route of the one or more candidate travel routes;
generating, by the processor, a summary associated with each of the at least one candidate travel routes using a machine learning technique based on the relevancy between the at least one parameter and each route of the one or more candidate travel routes, wherein the score is directly proportional of the relevancy between the at least one parameter and each route of the one or more candidate travel routes;
providing, by the processor, the summary of each of the at least one candidate travel routes alongside a preview of the at least one candidate travel routes;
receiving, by the processor, a second input for selection of a final travel route selected from the at least one candidate travel routes in response to providing the summary of each of the at least one candidate travel routes; and
providing, by the processor, turn-by-turn navigation guidelines to navigate the vehicle through the final travel route via the user interface.

16. The method for generating the travel route for navigation of the vehicle as claimed in claim 15, wherein the first input and the second input being provided using at least one diver input systems selected from the set of driver input systems consisting of a touch input, and a voice input.

17. The method for generating the travel route for navigation of the vehicle as claimed in claim 15, wherein the condition of the vehicle is identified using at least one sensor disposed within the vehicle, said at least one sensor monitoring at least one condition being selected from the set of conditions consisting of: the age of the vehicle, noise level of the vehicle, emission data, tire conditions, battery State of Health (SOH), and battery State of Charge (SOC).

18. The method for generating the travel route for navigation of the vehicle as claimed in claim 15, wherein the plurality of driver preferences comprises at least one preference selected from the set of preferences consisting of: lighting conditions during driving, daytime, nighttime, freeways, countryside roads, potholes, acceleration, speed, enroute traffic signals, enroute diversions due to construction, and accidents.

19. The method for generating the travel route for navigation of the vehicle as claimed in claim 15, wherein the past travel route history information comprises at least one past travel route history data selected from the set of data consisting of: user's previous routes, success rates, timings, and traffic history based on time of day and past days' averages.

20. The method for generating the travel route for navigation of the vehicle as claimed in claim 15, wherein the historical crime data comprises statistics on crimes along the plurality of candidate travel routes, wherein the diversion data comprises detours identified due to ongoing enroute constructions.
